(19) United States
(12) Patent Application Publication
(10) Pub. No.: US 2011/0104939 A1
(43) Pub. Date: May 5, 2011

(54) FLEXIBLE CIRCUIT BOARD CONNECTOR WITH ANTI-DISENGAGEMENT MOVABLE COVER

(76) Inventors: Hsien-Yu Chiu, Taoyuan (TW); Wen-Hsin Chen, Taoyuan (TW)

(21) Appl. No.: 10/761,298

(22) Filed: Jan. 22, 2004

(30) Foreign Application Priority Data
Oct. 31, 2003 (TW) 092219454

(51) Int. Cl. H01R 12/77

(52) U.S. Cl. 439/495

(57) ABSTRACT

A flexible circuit board connector with anti-disengagement movable cover collectively assembled and structured to include a lengthwise insulator, a U-shaped movable cover, a number of connecting terminals, and a pair of anti-disengagement panels. When the movable cover is pulled up, frontal sections of wing panels configured on left and right sides of the movable cover are subjected to confinement by blocking panels provided with functionality to fence therein, therewith preventing the wing panels of the movable cover from flexing or deformation, thereby preventing disengagement of the movable cover, and extending applicable life-span of the flexible circuit board connector, as well as enhancing an electrical connection of a flexible flat cable and the flexible circuit board connector therebetween.

### BACKGROUND OF THE INVENTION

(a) Field of the Invention

The present invention relates to a flexible circuit board connector with anti-disengagement movable cover.

(b) Description of the Prior Art

Referring to FIGS. 1 and 2, which show a configuration of a conventional flexible circuit board connector (10) structured to comprise a lengthwise insulator (11) (also known as a plastic center), which is mutually socket jointed with a U-shaped movable cover (12) (also known as a rear cover), and mounted on a printed-circuit board (70), thereby realizing an electrical connection with a flexible flat cable (FFC) (80) therebetween.

Wherein, slide grooves (11a), having functionality as guide tracks, are defined in two sidewalls of the insulator (11). Protruding locating blocks (11b) are respectively configured in frontal sections of channels of each of the slide grooves (11a). An interior of the insulator (11) is provided with a rabbet (14) and a number of terminal-receiving passages (15), and each of the terminal-receiving passages (15) are configured such to interlink with the rabbet (14). A number of connecting terminals (50) are embedded one by one into each of the terminal-receiving passages (15); and upon the flexible flat cable (80) being embedded within the rabbet (14), the electrical connection is realized with the connecting terminals (50), which therethrough realizes the electrical connection with the printed-circuit board (70).

Moreover, wing panels (13) are respectively configured on left and right sides of the movable cover (12), and each wing panel (13) is adapted with a slide piece (13b) on a frontal section thereof. A press-fit panel (16) is jointed between the two side wing panels (13), thereby allowing the movable cover (12) to assume a U-shape body. Upon the slide pieces (13b) configured on the frontal sections of the wing panels (13) being separately lodged into the slide grooves (11a) of the two side walls of the insulator (11), the movable cover (12) is thereby securely mounted onto the insulator (11) by means of the wing panels (13) configured on the left and right sides thereof. The flexible circuit board connector (10) is thereby collectively assembled from the movable cover (12) and the insulator (11).

Furthermore, collective utilization of the slide pieces (13b) configured on the movable cover (12) and the slide grooves (11a) of the insulator (11) constitutes a sliding mechanism, thereby allowing pulling up and covering of the movable cover (12) of the conventional flexible circuit board connector (10) thereof. Moreover, when pulling up the movable cover (12), the slide pieces (13b) configured on the movable cover (12) come in contact with the locating blocks (11b) configured on the frontal sections of the slide grooves defined in the insulator (11) thereof, and thereby confines separation between the movable cover (12) and the insulator (11) to a fixed distance, which not only prevents the movable cover (12) and the insulator (11) from disengaging, but also allows compete exposure of an opening of the rabbet (14) of the insulator (11). Thus, the press-fit panel (16) of the movable cover (12) will not be shielded, and thereby facilitates embedding the flexible flat cable (80) into the rabbet (14) of the insulator (11). Upon the movable cover (12) covering up the insulator (11), and thereby realizing a condition of the movable cover (12) abutting against the insulator (11), the press-fit panel (16) of the movable cover (12) extends within the rabbet (14) of the insulator (11), and therewith presses on the flexible flat cable (80), thereby allowing secure placement of the flexible flat cable (80) within the rabbet (14) of the insulator (11).

However, because the wing panels (13) of two sides of the aforementioned U-shaped movable cover (12) constitute a configuration of a long strip-like form, augmented with a configuration that compels the frontal sections of the wing panels to provide protruding slide pieces (13b), hence, thickness of the wing panels (13) of the movable cover (12) generally cannot be formed too thick, otherwise a comparatively insufficient resistance to intensity of deformation or flexing would result, and after usage, deformation and flexing phenomena will often occur, particularly, when a force of somewhat intensity is employed to pull up on the movable cover (12). In addition, the slide pieces (13b) configured on the left and right sides of the wing panels (13) regularly come away from being hooked by the locating blocks (11b) of the insulator (11), thereby causing the movable cover (12) to be no longer confined, and resulting in the movable cover (12) and insulator (11) coming apart. Consequently, the conventional flexible circuit board connector (10) cannot be reused, even if the slide pieces (13b) of the movable cover (12) are reinserted within the slide grooves (11a) of the insulator (11). While in usage, also deformation or flexing of the wing panels (13) of the movable cover (12) results in the flexible flat cable (80) being unable to be solidly secured down within the rabbet (14) of the insulator (11), with consequences of a bad electrical contact occurring between the flexible flat cable (80) and the flexible circuit board connector (10).

### SUMMARY OF THE INVENTION

Therefore, a primary objective of the present invention is to provide an original flexible circuit board connector, which can prevent a movable cover and an insulator of the flexible circuit board connector from coming apart, and thereby overcome the disadvantages of the conventional flexible circuit board connector.

A second objective of the present invention is to provide the flexible circuit board connector which prevents disengagement of the movable cover, whereby when the movable cover is pulled up, frontal sections of wing panels will be subjected to confinement by blocking panels provided with functionality to fence therein, therewith preventing the wing panels of the movable cover from flexing or deformation, and thereby extending applicable life-span of the flexible circuit board connector, and enhancing an electrical connection of a flexible flat cable and the flexible circuit board connector therebetween.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic elevational view and application of a conventional flexible circuit board connector.

FIG. 2 shows a cross sectional view of FIG. 1 along a 2-2 cross sectional axis depicting easy disengagement of a movable cover from an insulator when pulling up a movable cover.

FIG. 3 shows a schematic elevational view of the flexible circuit board connector according to the present invention.

FIG. 4 shows an exploded elevational view of components of the flexible circuit board connector according to the present invention.

FIG. 5 shows a cross sectional view of an insulator of FIG. 4 along a 5-5 cross sectional axis depicting formation of a joint having a chase tenon within a chase recess of the insulator according to the present invention.

FIG. 6 shows a cross sectional view of the insulator of FIG. 3 along a 6-6 cross sectional axis depicting an insert-fit panel of an anti-disengagement panel inserted into the chase recess of the insulator and lodged onto the chase tenon according to the present invention.

FIG. 7 shows a schematic elevational view and application of when the movable cover of the conventional flexible circuit board connector is pulled up according to the present invention.

FIG. 8 shows a cross sectional view of FIG. 7 along a 8-8 cross sectional axis depicting when the movable cover is pulled up, the anti-disengagement panels of the present invention can prevent disengagement of two side wing panels of the movable cover from the insulator according to the present invention.

FIG. 9 shows a schematic elevational view and application of when the movable cover of the conventional flexible circuit board connector is fully pulled up and secure according to the present invention.

FIG. 10 shows a cross sectional view of FIG. 9 along a 10-10 cross sectional axis depicting connecting terminals of the flexible circuit board connector and a flexible flat cable constituting a good electrical contact according to the present invention.

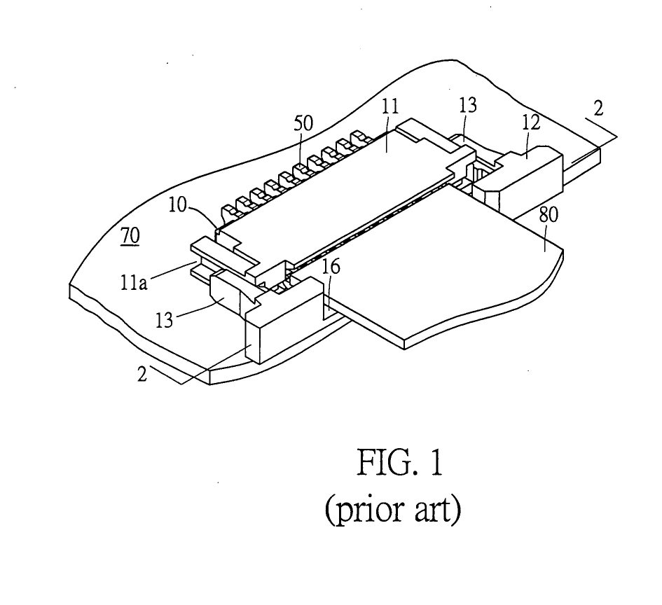

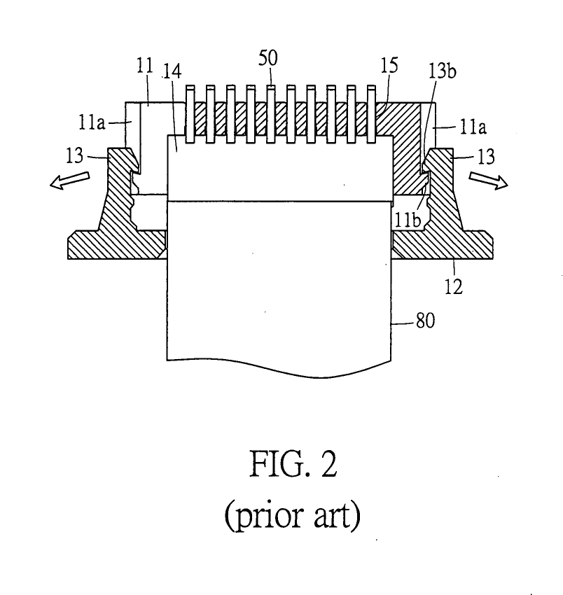

### DETAILED DESCRIPTION OF THE PREFERRED EMBODIMENTS

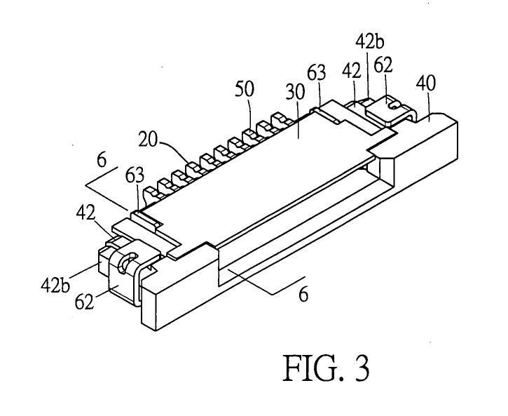

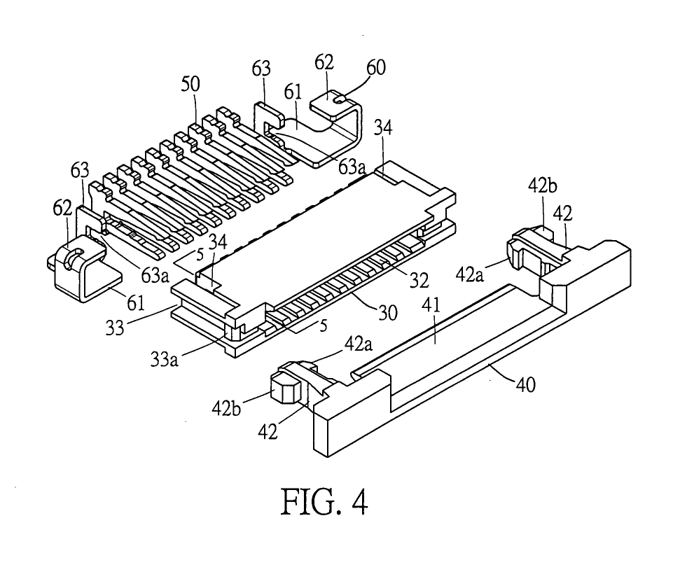

Referring to FIGS. 3 and 4, which show the flexible circuit board connector of the present invention (20) structured and collectively assembled to comprise a lengthwise insulator (30), a U-shaped movable cover (40), and a pair of anti-disengagement panels (60).

Wherein, an interior of the insulator (30) is structured same as is a conventional insulator, whereby the insulator (30) is provided with a rabbet (32) and a number of terminal-receiving passages configured to provide embedding of connecting terminals (50) therein. Slide grooves (33), having functionality as guide tracks, are defined in two sidewalls of the insulator (30). Moreover, protruding locating blocks (33a) are respectively configured in frontal sections of channels within each of the slide grooves (33).

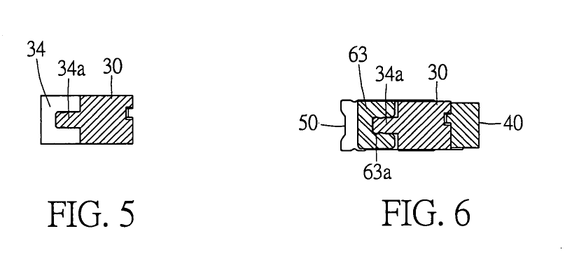

Furthermore, chase recesses (34) are separately configured as notches in surfaces of two side edges at a rear of the insulator (30). However, configured locations of the chase recess (34) are such that will not impair the slide grooves (33) formed from two side walls configured on two sides of the insulator (30). Moreover, interiors of the chase recess (34) are so defined to form chase tenons (34a) having a fracture surface as depicted in FIG. 5, and provided with functionality as a male tenon.

In addition, the movable cover (40) of the present invention is configured to define two differing structural embodiments, the movable cover (40) of the first embodiment is similar to that as configured for a conventional flexible circuit board connector, wherein, wing panels (42) having slide pieces (42a) are respectively configured on frontal sections of left and right sides of the movable cover (40). A press-fit panel (41) is jointed between the left and right side wing panels (42), thereby allowing the movable cover (12) to assume a U-shape body.

Regarding the movable cover (40) of the second embodiment, protruding pads (42b) are configured on another panel to that of the slide pieces (42a) configured on the frontal sections of the wing panels (42) of the movable cover (40).

Hence, upon the slide pieces (42a) configured on the frontal sections of the wing panels (42), which are respectively configured on left and right sides of the movable cover (40), being respectively lodged into the slide grooves (33) of the two side walls of the insulator (30), both movable covers (40) of the two different embodiments are capable of being collectively assembled with the insulator (30) to fabricate the flexible circuit board connector (20) therefrom.

The pair of anti-disengagement panels (60) are configured to assume mutually symmetrical panels, and each is equally structured from a lower panel (61), a blocking panel (62) and an insert-fit panel (63). Wherein, the lower panels (61) are adapted to be of short horizontal form, however, the blocking panels (62) can be adapted to be of a perpendicular panel form or as depicted in FIGS. 4 and 5, can be adapted to be of an inverse L-shaped panel form from a perpendicular and a horizontal panel, and the insert-fit panels (63) are of a perpendicular panel form, although such must be made to be parallel to the perpendicular panel of the blocking panels (62).

Therefore, the blocking panels (62) and the insert-fit panels (63) are separately bent to respectively form two sides of the lower panels (61), whereby a perpendicular surface of each of the blocking panels (62) is formed to be parallel to the insert-fit panels (63). Furthermore, recesses (63a) are defined so as to form notches in perpendicular surfaces of each of the insert-fit panels (63), and shape of the recess (63a) corresponds to that shape formed by the chase tenons (34a) configured within the chase recesses (34) of the insulator (30). Therefore, as depicted in FIGS. 3 and 6, the recesses (63a) of the insert-fit panels (63) configured on the anti-disengagement panels (60) are utilized to insert the insert-fit panels (63) of the anti-disengagement panel (60) within the chase recess (34) of the insulator (30), and thereby securely lodge same on the chase tenons (34a) therein.

According to the aforementioned, upon assemblage of the flexible circuit board connector of the present invention by collectively interlocking the anti-disengagement panels (60) and the insulator (30), the movable cover (40) and a number of connecting terminals (50), thereby allows pulling up the movable cover (40) to locate position of same, whereupon the frontal sections of the movable cover (40) are subjected to confinement by the blocking panels (62) of the anti-disengagement panels (60), no matter whether the blocking panels (62) are of the perpendicular panel form or adapted to form a L-shaped panel form from the perpendicular panel and the horizontal panel.

In view of the aforementioned, spacings between the blocking panels (62) of the anti-disengagement panels (60) and insert-fit panels (63) are thus defined with two differing specifications, and employment of which specification depends on conditions of application. When first specification is employed, and upon pulling up the movable cover (40), the frontal sections of the wing panels (42) of the movable cover (40) are subjected to confinement by the blocking panels (62) of the anti-disengagement panels (60), and therewith prevent disengagement of the movable cover (40) from the insulator (30). When employing the movable cover (40) of second specification, and upon pulling up the movable cover (40), the pads (42b) configured on the frontal sections of the wing panels (42) of the movable cover (40) are subjected to confinement by the blocking panels (62) of the anti-disengagement panels (60), and therewith prevent disengagement of the movable cover (40) from the insulator (30).

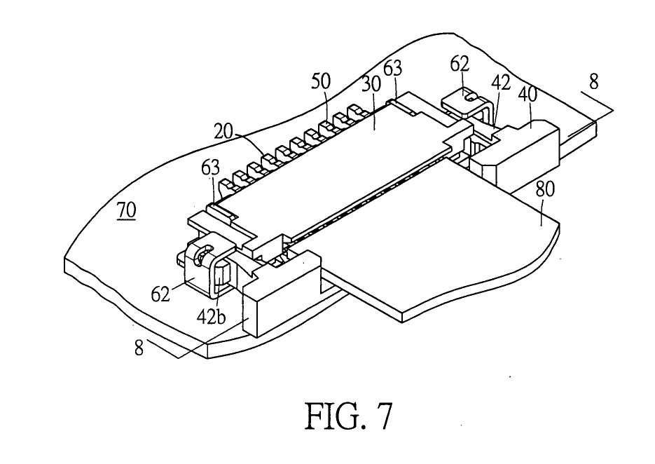

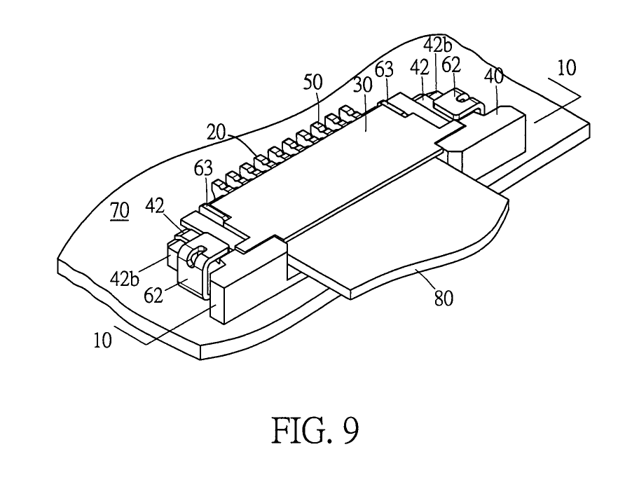

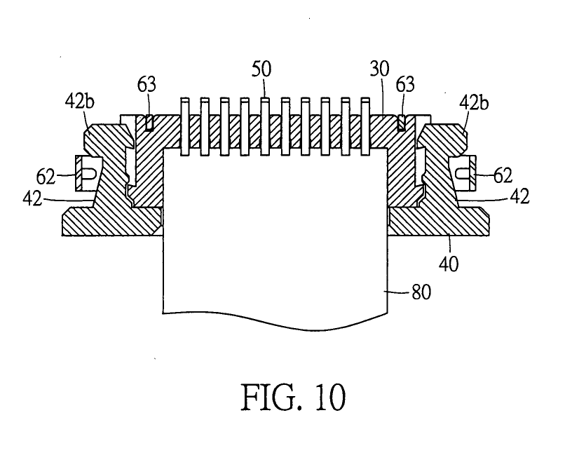

Referring to FIGS. 7 to 10, which show an embodiment of the flexible circuit board connector (20) of the present invention structured and collectively assembled to comprise a lengthwise insulator (30), a U-shaped movable cover (40), a number of connecting terminals (50), and a pair of anti-disengagement panels (60). Furthermore, the lower panels (61) of the anti-disengagement panels (60) are utilized to solder onto a printed-circuit board (70), which thereby secures mounting of the flexible circuit board connector (20) onto the printed-circuit board (70).

Wherein, the slide pieces (42a) and the pads (42b) are configured on the frontal sections of the wing panels (42) of the movable cover (40), and the blocking panels (62) of the anti-disengagement panels (60) are provided with the L-shaped panel defined from the perpendicular panel and the horizontal panel thereof. Therefore, an operating relation between the wing panels (42) of the movable cover (40) and the blocking panels (62) of the anti-disengagement panels (60) form a structure having drawer-like functionality.

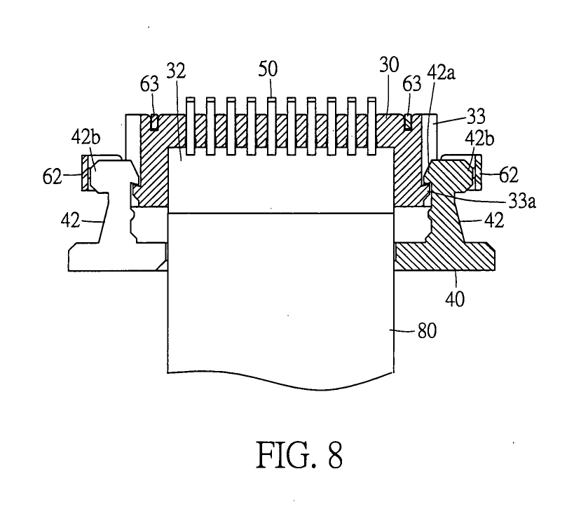

When in usage, as depicted in FIGS. 7 and 8, the movable cover (60) is first pulled and vertically slid until unable to pull any further, at this time, the slide pieces (42a) configured on the frontal sections of the wing panels (42) of the movable cover (40) come in contact with the locating blocks (33a) configured on the frontal section of the channels within the slide grooves (33) of the insulator (30).

The pads (42b) configured on the frontal sections of the wing panels (42) of the movable cover (40), are thereby lodged in the blocking panels (62) of the anti-disengagement panels (60) and subjected to confinement by the blocking panels (62) provided with functionality to fence therein, therewith preventing the wing panels (42) of the movable cover (40) from flexing or deformation, and preventing disengagement of the movable cover (40) from the insulator (30).

When the flexible flat cable (80) is embedded into the rabbet (32) of the insulator (30), whereby the connecting terminals (50) are embedded within the terminal-receiving passages, an electrical current is realized therewith. Operating in reverse order, the movable cover (40) is pushed into and abutted against the insulator (30), thereby allowing the press-fit panel (41) of the movable cover (40) to extend within the rabbet (32) of the insulator (30), and holding fast the flexible flat cable (70) within the rabbet (32) of the insulator (30), and thus allowing the flexible flat cable (80) and the printed-circuit board (70) to constitute a good electrical connection thereof.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A flexible circuit board connector with anti-disengagement movable cover, comprising a lengthwise insulator, a U-shaped movable cover, and a pair of anti-disengagement panels, wherein slide grooves are defined in two sides of an insulator, and chase recesses are configured as notches in rear walls of the insulator; wing panels having slide pieces are configured on frontal sections of left and right sides of the movable cover, moreover, the slide pieces of the wing panels lodge into the slide grooves of the insulator; the pair of anti-disengagement panels are configured to assume a mutually symmetrical entity, whereby each is equally structured from a lower panel, a blocking panel and an insert-fit panel, the lower panels are adapted to be horizontally defined, while the blocking panels are adapted to be of a perpendicular panel form, and the insert-fit panels are of a perpendicular panel form, thereby a mutually parallel structure is defined from the mutually separated perpendicular panels, and therefrom form two upright sides of the horizontal lower panel furthermore, the insert-fit panels lodge into the chase recesses of the insulator, and when pulling up the movable cover, the blocking panels of the anti-disengagement panels confines the wing panels of the movable cover by means of the perpendicular panels so as to prevent disengagement of the movable cover from the insulator.

2. The flexible circuit board connector according to claim 1, wherein slide pieces and pads are configured on the frontal sections of the wing panels of the movable cover.

3. The flexible circuit board connector according to claim 1, wherein chase ribs assuming male tenon-shapes are configured within the chase recesses of the insulator, and corresponding chase rib-shaped recesses are configured in the insert-fit panels of the anti-disengagement panels.

4. The flexible circuit board connector according to claim 2, wherein chase ribs assuming male tenon-shapes are configured within the chase recesses of the insulator, and corresponding chase rib-shaped recesses are configured in the insert-fit panels of the anti-disengagement panels.

5. The flexible circuit board connector according to claim 1, wherein the blocking panels of the anti-disengagement panels are provided with an inverse L-shaped panel defined from the perpendicular panel and a horizontal panel.

6. The flexible circuit board connector according to claim 2, wherein the blocking panels of the anti-disengagement panels are provided with an inverse L-shaped panel defined from the perpendicular panel and a horizontal panel.

7. The flexible circuit board connector according to claim 1, wherein the blocking panels of the anti-disengagement panels are adapted to be of perpendicular panel form.

8. The flexible circuit board connector according to claim 2, wherein the blocking panels of the anti-disengagement panels are adapted to be of perpendicular panel form.

9. The flexible circuit board connector according to claim 3, wherein the blocking panels of the anti-disengagement panels are adapted to be provided with the inverse L-shaped panel defined from the perpendicular panel and horizontal panel.

10. The flexible circuit board connector according to claim 3, wherein the blocking panels of the anti-disengagement panels are adapted to be of perpendicular panel form.
